(19) United States
(12) Patent Application Publication
(10) Pub. No.: US 2015/0350848 A1
(43) Pub. Date: Dec. 3, 2015

(54) REMOTE MONITORING OF USERS AT A HOME LOCATION

(71) Applicant: EBAY INC., San Jose, CA (US)

(72) Inventor: David Edward Eramian, San Jose, CA (US)

(21) Appl. No.: 14/292,374

(22) Filed: May 30, 2014

(51) Int. Cl. H04W 4/04; H04M 11/04; H04M 1/725; H04W 4/22

(52) U.S. Cl. CPC H04W 4/04; H04W 4/22; H04M 11/04; H04M 1/72533

(57) ABSTRACT

There are provided systems and methods for remote monitoring of users at a home location. A user may set up a series of wireless beacons at a location of the user, such as a home location. The wireless beacon may be established in each room or a sub-area in each room. The wireless beacons may connect to devices as the devices enter a coverage area for the wireless beacons. Each beacon may be limited in range to a particular part of the location. Using the beacons, the user may monitor the movement of a device attached to another person or animal. Additionally, the user is made aware of the devices location during an emergency, such as a fire, to rescue the person/animal. The device may also be connected to the user, so the user may be informed of dangerous situations if the user is not detected at the location.

### TECHNICAL FIELD

The present application generally relates to remote monitoring of users at a home location and more specifically to providing wireless beacons throughout a location that may connect to a device held by a user in order to determine an area the user is located at and take further actions.

### BACKGROUND

Parents of children, owners of pets, and caretakers for elderly persons all may wish to monitor their respective charges while they are away from their home. Present monitoring techniques provide little information, may not provide accurate enough locations of person being monitored, are expensive to set up, or may provide an over-invasion of the person's privacy. For example, a home camera surveillance system can cost hundreds, if not thousands of dollars, and be difficult to set up in a home. Moreover, the system requires a large data bandwidth to provide video feed and can over expose some people who may feel uncomfortable having cameras constantly trained on them. Other motion based surveillance methods provide little information aside from a motion of a user in a location. Some users may hire other care providers, such as baby sitters, dog/cat sitters, nurses, etc., that may visit the location to monitor and assist the wards of the user; however, such services may be expensive.

Users may also wish to receive updates and information on emergencies and situations at their house when the user is not located at the house. For example, the users may wish to be made aware if a fire is occurring at their house and whether any person or animal is still currently located in the house. This information may also be of importance to emergency personnel when responding to the emergency. However, present smoke detectors provide little information on actual persons and/or animals whereabouts in the house. Additionally, if the situation at the house is only an unlocked door or open garage, the user may not be made aware of the potentially risky situation until the user returns to their house.

### BRIEF DESCRIPTION OF THE DRAWINGS

FIG. 1 is a block diagram of a networked system suitable for implementing the processes described herein, according to an embodiment;

FIG. 2A is an exemplary environment displaying remote monitoring of a ward by their guardian, according to an embodiment;

FIG. 2B is an exemplary environment displaying remote monitoring of a user and pet at a home location during an emergency, according to an embodiment;

FIG. 2C is an exemplary environment displaying remote monitoring of dangerous or risky situations while a user is away from home, according to an embodiment;

FIG. 3 is an exemplary display screen of a user device showing monitored information for a user at a home location, according to an embodiment;

FIG. 4 is a flowchart of an exemplary process by a server for remote monitoring of users at a home location, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations may provide short range wireless communications with a device, such as through Bluetooth Low Energy (BLE) beacon communications. These beacons may be set up at a location and communicate with devices to detect a device in proximity to the beacon and alert users of check-in services through their device. The beacons may provide additional functionality, such as establishing a connection with a server entity to complete transactions, including check-in services. The beacons may provide communications to the devices directly, including information stored in the beacons. The beacons may also provide communication with a device attached to, or in communication with, the beacon, such as another device of another user.

A user, such as a homeowner, caretaker, or guardian of another individual, may set up one or more wireless beacons throughout a location where another person or animal resides. For example, the short range wireless beacon may be established throughout a home location of the user. The wireless beacons may utilize short range wireless communications to detect another device on, possessed by, or attached to the person/animal. The beacon may employ BLE communications that emit a signal receivable by the device. The communication may include an identifier for the beacon, the user, and/or a service provider offering monitoring and/or check-in services through the wireless beacons. The device may be set up to passively monitor for BLE communications. When the device detects the signal and verifies the one or more identifiers, both the device and the beacon may ramp up in power and establish a connection, where the connection may further enable the device to communicate with the service provider's server. The beacon may be connected to a networked device at the home location of the user, or the beacon may include network functionality to communicate with other devices and/or servers, including a user device of the user corresponding to the home location. Thus, the beacon enables the device to provide the wireless beacon with check-in, location, or identification information for the person/animal at the home location of the user. A check-in may be completed automatically when the device is in range of the beacon, or may be completed after prompting the holder of the device to check-in when the device is in range of the beacon. The user may limit the range of the beacon to a distance within the home location and spread multiple wireless beacons throughout the home location. Thus, each wireless beacon may correspond to an area of the home (e.g., kitchen, bedroom, bathroom, living room, etc.). Therefore, when a connection is established between the device and one of the wireless beacons, a location for the device, and thus the person/animal corresponding to the device, may be determined based on the connection and knowledge of where the wireless beacon forming the connection is located.

Using the wireless beacons and the device, info nation may be determined by monitoring the device's movement throughout the location based on the connections the device makes with the wireless beacons. For example, if the device remains in one spot for a longer than normal period of time, the user (e.g., homeowner, caretaker, etc.) may determine that something may have happened to the person/animal attached to the device. If the device is in an unauthorized area, such as in a parent's bathroom or a kitchen when the device is attached to a young child, the parent may be notified. Additionally, the service provider may monitor the changes in movement over a longer period of time. Thus, a caretaker of an elderly person may be made aware that the elderly person is spending a longer amount of time in the bathroom or in bed than they have over the past few months in order to determine if a care program needs to be adjusted or a doctor's visit is in order.

The wireless beacons may also provide assistance during an emergency. For example, a home location of a user may have a fire occur in the home. Based on devices attached to other persons/animals at the location, the wireless beacons may display a location of those other persons/animals to the user. The user may then be able to provide assistance quickly without having to search throughout the home. The location of the other persons/animals may also be transmitted for display to emergency personnel, such as a firefighter, so they may provide assistance. The wireless beacons may also be connected to smoke alarms, fire sprinklers, intercoms, automated locks, etc., which may provide information and assistance to the emergency personnel. If the user has a powered garage door opener, smart/automatic door locks, and/or automatic pet doors, the wireless beacons may be attached to the door openers and configured to allow persons/animals to exit a dangerous situation and prevent their re-entry on command.

The wireless beacons may also interact with a user device held by the user establishing the wireless beacons throughout their home. For example, the wireless beacons may check-in the user or detect that the user is within the home. When the user leaves the home and their user device disconnects for the wireless beacon(s), other information available to the wireless beacons or the service provider may be communicated to the user if the other information present a dangerous or undesirable situation. For example, the user may forget to close a garage door or lock a front door that has a smart/networked lock. At other times, the user may be alerted an oven, appliance, faucet, etc., has been left turned on. Thus, the user may view the adverse situation and take desired actions, such as returning home, notifying others, or instructing the networked device to power off/close. The service provider may also provide geo-location for users corresponding to the home, so that the nearest user to the home may be alerted.

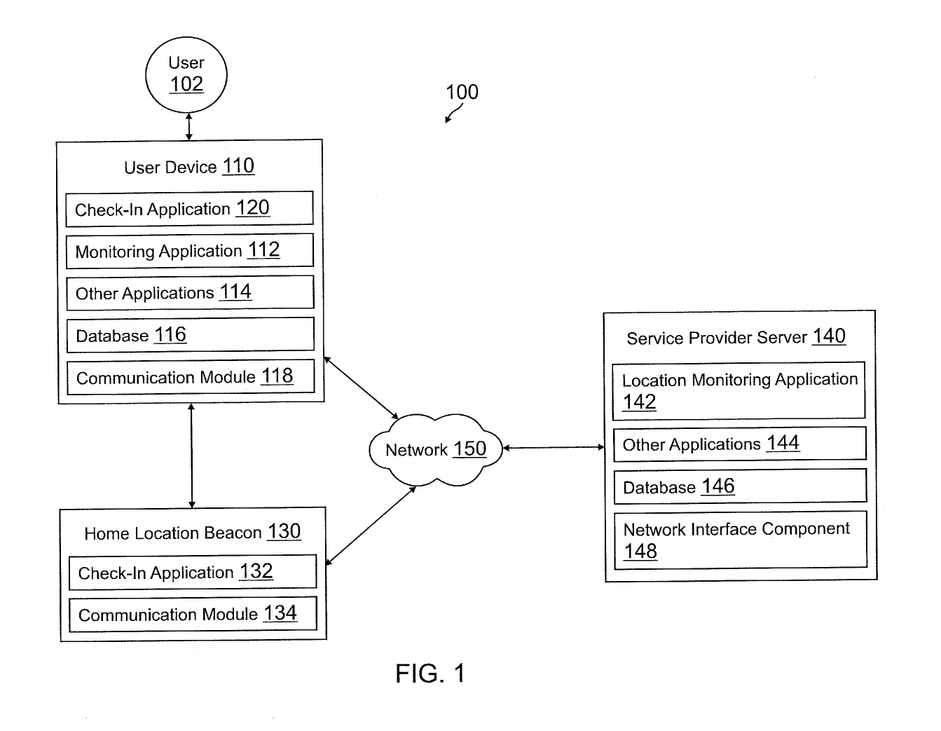

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a home location beacon 130, a user device 140, and service provider server 140 in communication over a network 150. User 102, such as a homeowner, caretaker, resident at a home (e.g., child/elderly individual), etc., may use user device 110 to connect to home location beacon 130 and place user 102 in a location within the home. In some embodiments, user device 110 may even correspond to a small communication module/tag and be placed on a pet (e.g., on a collar), or with a wristband or item of clothing of a ward. Service provider server 140 may determine information based on the connection between user device 110 and home location beacon 130, as well as other devices, appliances, or resources available to home location beacon 130. The information may be routed to user device 110 and/or a user device of another user (e.g., the caretaker/homeowner, emergency personnel, etc.).

User device 110, home location beacon 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication with home location beacon 130 and/or service provider server 140. For example, in one embodiment, user device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. In other embodiments, less than the discussed features may be included in user device 110. For example, user device 110 may also correspond to a small processing device and/or tag that may be included in or attached to a watch, wallet, necklace, clothing item, or other wearable piece and configured to only establish a communication with home location beacon 130 in order to monitor a movement of user 102 throughout a location with a plurality of wireless beacons. Although a user device is shown, the user device may be managed or controlled by any suitable processing device. Although only one user device is shown, a plurality of user devices may function similarly.

User device 110 of FIG. 1 contains a monitoring application 120, a check-in application 112, other applications 114, a database 116, and a communication module 118. Monitoring application 120, check-in application 112, and other applications 114 may correspond to processes, procedures, and/or applications executable by a hardware processor, for example, a software program. In other embodiments, user device 110 may include additional or different software as required.

Check-in application 112 may be used by user 102 of user device 110 to establish a connection with home location beacon 130, including a check-in using service provider server 140 or another device/server. Check-in application 112 may correspond to a specific application utilized by user device 110 with service provider server 140 to complete a check-in for a location corresponding to home location beacon 130. The check-in with service provider server 140 may correspond to a process to log in to a user account of user 102 with service provider server 140. In other embodiments, the check-in may provide and/or verify the identity of user 102, including transmission of an identifier for user 102 and/or user device 110. The check-in may be completed over network 150 with service provider server 140. In such embodiments, check-in application 112 may correspond more generally to a browser application configured to communicate with service provider server 140.

Check-in application 112 may also receive short range wireless communications from home location beacon 130 at a location and transmit information to home location beacon 130, including check-in information for a check-in process with service provider server 140 that associates user 102 with the location corresponding to home location beacon 130. For example, the location for home location beacon 130 may correspond to a room in a home location (or office, business, etc. location) where home location beacon 130 is set up to communicate with user device 110 when user device 110 is in the room. In such an example, home location beacon 130 may be range limited to correspond only to the room (or a sub-area of a room), and a plurality of other beacons may be distributed throughout the location, each capable of uniquely connecting to user device 110. Home location beacon 130 may be set to be range limited, or may be limited to the room by virtue of walls or other barriers that prevent transmission of communications to user device 110, as will be explained in more detail herein. Thus, check-in application 112 may transmit information to home location beacon 130 when user 102 is nearby home location beacon 130 (e.g., in the room for home location beacon 130) enabling service provider server 140 to triangulate the position of user 102 within the location and associate user 102 with an area of the location.

Check-in application 112 may execute in the background of an operating system of user device 110 and be configured to establish connections, using communication module 118 of user device 110, with home location beacon 130 in an area of a location corresponding to user 102. The connection may be established with or without user input from user 102. For example, home location beacon 130 may broadcast a token, such as a universally unique identifier (UUID), for reception by check-in application 112, as will be explained in more detail herein. Check-in application 112 may utilize communication module 118 of user device 110 to receive the token from home location beacon 130. If check-in application 112 acknowledges the UUID as identifying home location beacon 130 and/or service provider server 140 (e.g., if check-in application 112 determines the UUID corresponds to a request to complete a check-in), check-in application 112 may transmit an identifier corresponding to user 102 and/or user device 110 back to home location beacon 130. Check-in application 112 may utilize communication module 118 of user device 110 to communicate with home location beacon 130 (e.g., over near field communication, Bluetooth, Bluetooth Low Energy, radio, infrared, LTE Direct, or other connection). The identifier from user device 110 may include, be transmitted with, concatenated with, or otherwise bundled with the identifier received from home location beacon 130. In other embodiments, different information may be transmitted to home location beacon 130, such as location information for user 102 (e.g., a message containing a “user 102 is located at home location beacon 130”). Thus, the information transmitted to home location beacon 130 does not need to be utilized to process and/or complete a check-in with service provider server 140 in all embodiments.

Once a connection is established with home location beacon 130, user device 110 may be checked-in with service provider server 140 if user 102 has not previously been checked-in. The check-in process may then associate user 102 with home location beacon 130 used to check-in user 102. For example, user 102 may previously have registered home location beacon 130 as located in a specific area of a location (e.g., within a room of a home location). Thus, service provider server 140 is informed that user 102 is in an area to the location because user 102 connects to home location beacon 130 using user device 110. As previously discussed, in other embodiments, a check-in need not be processed and/or completed to associate user 102 with the area. Thus, other connections and data transfers to home location beacon 130 may be sufficient to associate user 102 with home location beacon 130 in an area of the location. In other embodiments, home location beacon 130 may be established in an area of a workplace, business, merchant storefront, or other location.

Check-in application 112 may also transmit and/or receive information. For example, check-in application 112 may transmit information for other devices and/or applications for user device 110. The other devices/applications may include heart, blood, lung, or other vital statistic monitoring devices/applications, sound, air and/or light monitoring devices/applications, etc. Information from these devices/applications may be passed to service provider server 140 for additional monitoring of user 102 attached to user device 110. Check-in application 112 may also issue a command to a device attached to home location beacon 130, such as a command to open or close an automated door attached to home location beacon 130, provide an emergency item from a device attached to home location beacon 130, etc. Check-in application 120 may also receive information from home location beacon 130, such as emergency information, emergency personnel instructions, communications from another user, maps of a location, etc. In other embodiments, user device 110 may be a small device attached to a wearable item of a person/animal and check-in application 112 may only provide an identifier, check-in information, and/or location information to home location beacon 130.

Check-in application 112 may utilize communication module 118 to pass information to home location beacon 130 and/or service provider server 140. For example, information passed to home location beacon 130 and/or service provider server 140 may include information for user 102, such as a name or other identification information for user 102. As previously discussed, check-in application 112 may provide check-in information to service provider server 140 directly or through home location beacon 130. Additionally, check-in application 112 may also provide service provider server 140 with information for user 102 and/or user device 110, including user histories, user messages, etc.

Monitoring application 120 may be executed to provide an interface whereby user 102 may monitor the activity of another user and a location. Thus, monitoring application 120 may receive information from service provider server 140 about a person/animal (e.g., a child, a relative, a pet, etc.) currently at a location where home location 130 and other wireless beacons have been set up to remotely monitor the location and persons/animals at the location. In this respect, monitoring application 120 may receive location and/or movement information for the person/animal at the location. For example, user 102 may utilize monitoring application 120 to view an area and/or room that the person/animal is located in by virtue of their connection between a device and a wireless beacon in the area. Thus, user 102 may be informed if the person/animal is in an unauthorized area. Service provider server 140 may also track the person/animal's movement over a period of time and update user 102 of the movement throughout the location using monitoring application 120. The movement may include statistics on changes in movement, such as increased time spent in bed, in the bathroom, and/or other area. These movements may inform user 102 of potential injuries, disabilities, or medical attention required by the person/animal. If the person/animal alters their normal routine, an alert may be presented to user 102 through monitoring application 120 that may inform user 102 that attention is required. For example, if the person/animal is in a bathroom or kitchen late at night, user 102 may be alerted that this is atypical for the person/animal. Monitoring application 120 may also present an alert if the person/animal remains unmoving or sedentary for a longer than normal period of time. Determination of this information may be done by service provider server 140 using home location beacon 130, as will be explained in more detail herein. Additional information for the person/animal may also presented to user 102 through monitoring application 120, such as vital statistics taken from the device attached to the person/animal, messages sent from the device, etc.

During an emergency, monitoring application 120 may also be used to determine where the person/animal is in the location using the connection between the device attached to the person/animal and home location beacon 130. For example, if a fire occurs in a home location, user 102 may view the wireless beacon (e.g., home location beacon 130) that the device is connected to, and determine that the person/animal is in proximity to that device, and, thus, that area of the location. In various embodiments, home location beacon 130 may also be attached to a smoke detector, fire sprinkler, or other detector at the location, and provide user 102 with statistics from the detector. User 102 may also correspond to an emergency responder, who may view the location of the person/animal. The emergency responder may also receive a map, layout, or other information for the location to pinpoint the area where the person/animal is located at in the location.

As previously discussed, check-in application 112 may be utilized to authorize entry of a person/animal or prevent re-entry of that person/animal when an emergency or dangerous position may occur. Further, monitoring application 120 may also be utilized to monitor automatic doors, such as garage doors, pet doors, and automatic locks on entry doors, in the case of an emergency. If a door is locked so that it is preventing escape for a person/animal, monitoring application 120 may display the door and enable user 102 to unlock or open the door. Monitoring application 120 may also be utilized to close or lock the same doors to prevent re-entry to a dangerous situation. Such information concerning emergency situations may be provided to user 102 in real-time.

Situations that are dangerous or undesirable may also be presented to user 102 through monitoring application 120. Service provider server 140 may monitor the location of user 102 and/or other persons/animals, as previously discussed. If a situation occurs that would not be immediately apparent, user 102 may be alerted through monitoring application 120. For example, user 102 may leave a room or a location entirely, and, thus, disconnect from home location beacon 130 for the area/location. However, user 102 may have left a door connected to a smart/automatic lock unlocked, a garage door open, or an appliance (e.g., over, toaster, air conditioner/heater) on. If home location beacon 130 is connected to these devices to monitor their situations, service provider server 140 may update user 102 of their status. Service provider server 140 may also use geo-location to determine if user 102 is the closest user to the location to remedy the situation, and transmit the alert for the dangerous/undesirable situation to the closest user. User 102 may also utilize monitoring application 120 to close, lock and/or turn off the device(s) connected to home location beacon 130.

In various embodiments, one or more features of check-in application 112 and/or monitoring application 120 may be incorporated in the same application so as to provide their respective features in one application.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with service provider server 140. Other applications 114 may include browser and/or mapping applications where the functions are not provided by check-in application 112 and/or monitoring application 120. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 112, other applications 114, and/or monitoring application 120, identifiers associated with hardware of user device 110, or other appropriate identifiers, such as identifiers used for payment/user/device authentication or identification. Identifiers in database 116 may be used by a service/payment/credit provider, such as service provider server 140, to associate user device 110 with a particular account maintained by the provider. Database 116 may include user device tokens and/or encryption keys, including an encryption key of home location beacon 130 and/or service provider server 140. Database 116 may include identifying information for tokens enabling check-in application 112 to identify home location beacon 130 and/or service provider server 140 when receiving a corresponding check-in token.

Database 116 may further include information corresponding to user 102, including vital statistics, messages, or other information, which may be transmitted to service provider server 140. Information from database 116 may be utilized by service provider server 140 in conditions, emergencies, and/or situations that may arrive at a location for home location beacon 130. Information received from service provider server 140 may also be stored to database 116, including messages from other users, location/statistic information for the other users, and/or information for a location corresponding to home location beacon 130 (e.g., a map, layout, etc., of the location).

User device 110 includes at least one communication module 118 adapted to communicate with home location beacon 130 and/or service provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with home location beacon 130 using short range communications, such as radio frequency, infrared, Bluetooth, LTE Direct, and near field communications.

Home location beacon 130 may be maintained, for example, by user 102 and/or another user. Home location beacon 130 may also be maintained and/or utilized by service provider server 140. Home location beacon 130 may be implemented using any appropriate hardware and software configured for wireless communication with user device 110 and/or service provider server 140. For example, in one embodiment, home location beacon 130 may be implemented as a dongle device including a hardware processor and a communication module, for example, connected to device at a location corresponding to user 102 and/or another person/animal. Home location beacon 130 may also be implemented as a device incorporated within a personal computer (PC), a smart phone, wearable computing device, laptop computer, and/or other types of computing devices capable of transmitting and/or receiving data, such as an IPAD® from APPLE®. Home location beacon 130 may also act as a stand-alone device including a processor, communication module, and/or network interface component configured to communicate with user device 110 and/or service provider server 140. Although a single beacon is described, a plurality of wireless beacons may be utilized at the location.

Home location beacon 130 may be located at a physical location corresponding to user 102 and/or another person/animal. A physical location may constitute a home location, a work location, an office, or other location associated with user 102. Home location beacon 130 may further be established in an area of the location so as to provide communications between devices in that area and only home location beacon 130. Thus, a communication module 134 of home location beacon 130 may be limited in range to correspond to a sub-area of a location. Therefore, it may be determined that the devices that connect to home location beacon 130 are located within the area/sub-area of the location. Home location beacon 130 of FIG. 1 contains processes, procedures, and/or applications executable by a hardware processor, for example, a software program, configured to interact with user device 110 and/or service provider server 140. Thus, regardless of the implementation of home location beacon 130, as discussed above, home location beacon 130 utilizes a check-in application 132 and a communication module 134. In other embodiments, home location beacon 130 may include additional or different software and devices as required.

Check-in application 132 may correspond to an application for transmitting requests to establish a connection between a device (e.g., user device 110) and home location beacon 130. Thus, home location beacon 130 may utilize short range wireless communications of home location beacon 130 to transmit the requests to establish a connection, including an identifier such as a Universally Unique Identifier (UUID). If user device 110 (or another device attached to a person/animal in an area of a location corresponding to home location beacon 130) receives a request to establish the connection with home location beacon 130 and responds with a user device identifier (potentially including the UUID and other information necessary to effectuate a check-in of user device 110), check-in application 132 may cause home location beacon 130 to ramp up in power and create a connection between user device 110 (or the other device) and home location beacon 130.

Home location beacon 130 may transmit the request to establish the connection with home location beacon 130 as a short range wireless communication (e.g. a BLE protocol communication) including a “wake up” process for a device application (e.g., check-in application 112 of user device 110) and/or a token for home location beacon 130. In other embodiments, the request and/or connection may utilize near field communication, radio communication, infrared communication, or Bluetooth communication. Additionally, although home location beacon 130 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to home location beacon 130 (e.g., user device 110) and establishment of a connection for data transfers. The request may be specific to the device by including information that is specific to the user/device determined from information previously provided to service provider server 140. Thus, in certain embodiments, only the specific device will pick up and authenticate the request.

After check-in application 132 receives an identifier from the device, check-in application 132 may determine the user/person/animal is in proximity to home location beacon 130. Home location beacon 130 may pass the identifier to service provider server 140 to complete the check-in process. As shown in FIG. 1, home location beacon 130 may utilize a network connection of home location beacon 130 to pass the identifier to service provider server 140. In other embodiments, service provider server 140 may not process and complete a check-in, and the received identifier may be used only to determine an area/position of the device, and thus the user/person/animal corresponding to the device, within a location. Additionally, check-in application 132 may cause home location beacon 130 to keep a communication channel open between the device and service provider server 140 for passing additional information, such as monitoring information for a person/animal attached to the device, messages from the device, etc.

In various embodiments, home location beacon 130 includes at least one communication module 134 adapted to communicate with user device 110 and/or service provider server 140. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate with user device 110 using short range communications, such as radio frequency, infrared, Bluetooth, LTE Direct, and near field communications.

Service provider server 140 may be maintained, for example, by an online payment service provider, which may provide check-in and monitoring services on behalf of a user. In this regard, service provider server 140 includes one or more processing applications which may be configured to interact with user device 110 and/or home location beacon 130 to receive check-in or location information and monitor movement and other information for a person/animal at a location. In one example, service provider server 140 may be provided by PAYPAL®, Inc. of San Jose, Calif., USA. However, in other embodiments, service provider server 140 may be maintained by or include other service providers.

Service provider server 140 of FIG. 1 includes a location monitoring application 142, other applications 144, a database 146, and a network interface component 148. Location monitoring application 142 and other applications 144 may correspond to processes, procedures, and/or applications executable by a hardware processor, for example, a software program. In other embodiments, service provider server 140 may include additional or different software as required.

Location monitoring application 142 may process and/or complete a check-in between and device and home location beacon 130 (e.g., between user device 110 or a device possessed by another person/animal and home location beacon 130). Thus, location monitoring application 142 may correspond to the server side application of service provider server 140 configured to receive check-in information and complete a check-in request. The check-in request may include log in information for a user account in database 146 and thus complete the check-in by verifying the account information. For example, the check-in information may include an identifier or other account information for a user/payment account set up with service provider server 140. However, in embodiments where a user account has not been previously established, location monitoring application 142 may receive other information identifying the user/person/animal (e.g., user 102 or a ward, pet, etc. of user 102), including a user name/identifier, user device identifier, an identifier for an account with another server, or other information. As previously discussed, other information may be provided to service provider server 140, including a notification that the device in possession of the user/person/animal is within range to be detected by home location beacon 130.

Once the information is received from home location beacon 130 indicating a position or area within a location where an entity having an attached device is located, location monitoring application 142 may determine additional data based on the location information. For example, movement of the person/animal with the attached device may be tracked through a location by monitoring which wireless beacons (e.g., home location beacon 130) that the device has connected to. A pattern of movement may therefore be deduced by location monitoring application 142. Deviations from the pattern of movement may also be determined by location monitoring application 142. The deviations may occur once, over a short time period, or over a longer time period. Thus, if the device is detected in a bathroom, kitchen, or other area during an abnormal time (e.g., very late at night), location monitoring application 142 may transmit an alert to another user for viewing (e.g., user 102 through monitoring application 120 of user device 110). The movement changes may also correspond to a lack of change in movement, such as the device remaining in the bedroom past a normal hour where the person/animal may leave the bedroom. In other embodiments, if the device is spending longer in a bathroom, bedroom, etc., than normal for their pattern of behavior, the other user may also be alerted than that the person/animal in possession of the device is exhibiting more subtle symptoms that may require attention.

Location monitoring application 142 may transmit a notification to user 102 based on user settings covering the monitored person/animal's position/area within a location, the length of time at the location, the time of day and/or week, and the movement within the location. Thus, user 102 may request to view a notification if the person/animal is within an area late at night on weeknights, but not have the same concerns on weekends. User 102 may also set the parameters of a grandmother to be separate from that of a dog at the residence. Thus, if the grandmother is in an area late at night or is slow to travel between rooms in the morning, user 102 may be alerted. However, user 102 may not have similar concerns for a pet.

In other embodiments, location monitoring application 142 may track the position/area within a location of a device attached to a person/animal during an emergency situation. For example, a fire may occur at a location. Location monitoring application 142 may determine an emergency is occurring based on a device attached to home location beacon 130, such as a smoke alarm or fire sprinkler. In other embodiments, location monitoring application 142 may also be alerted for the emergency by another entity, such as emergency personnel, or the information may be requested from location monitoring application 142 by the entity. Location monitoring application 142 may provide the position/area of all devices attached to wireless beacons (e.g., home location beacon 130) at the location so that the party or parties receiving the location information may be able to locate the persons/animals corresponding to those devices. Thus, parents, guardians, pet owners, emergency personnel, etc., may quickly locate and provide assistance to those persons/animals. Location monitoring application 142 may also perform other tasks to aid the in rescue/assistance to those persons/animals, such as unlocking/openings doors, garages, and/or pet doors that may normally be closed in the event of the emergency. Location monitoring application 142 may also lock, close, or otherwise prevent re-entry to those persons/animals or other parties through doors that may expose them to the emergency. The system may generate and transmit notification about emergencies to user 102 based on default settings, such as earthquake alerts, emergency broadcast notifications, and/or detection of smoke. However, user 102 may also set parameters to detect emergency situations, such as a child or animal outside during warm temperatures and/or nearby a pool or other dangerous condition of a property.

Location monitoring application 142 may also monitor that user 102 and/or other users have left a location to apprise those users of unsafe and/or undesirable situations at the location. For example, it may be determined by location monitoring application that user 102 has left a location by receiving information from home location beacon 130 that user 102 has disconnected from home location beacon 130 and, thus, no longer within the area covered by home location beacon 130. In certain embodiments, user device 110 may even connect to a wireless beacon at another location far from the location for home location beacon 130 (e.g., at a merchant, another user's home, an office, etc.). Based on this information and other information available to service provider server 140, user 102 may be updated of dangerous/undesirable situations. Such situations may correspond to open garage doors, unlocked doors/windows, appliances left in the “on” position, etc. In certain embodiments, location monitoring application 142 may assist user 102 in remedying the situations, such as issuing a close command to a network garage door opener, a lock command to smart/networked doors/windows, enabling manual operation, or turning of a networked appliance (e.g., a heater/air conditioner, oven, stove, etc.). Location monitoring application 142 may also monitor the amount of time user 102 has spent away from a location, so that user 102 may not be alerted of an open garage until user 102 has spent more than 5 minutes away from the location. Location monitoring application 142 may still detect another person/animal at the location, but still alert user 102 of the status of situations at the residence in case is presents a potential dangerous situation to the person/animal (e.g., if an air conditioner has failed or is not turned on for a child or animal at a residence during hot temperatures).

In various embodiments, service provider server 140 includes other applications 144 as may be desired in particular embodiments to provide features to service provider server 140. For example, other applications 144 may include security applications for implementing server-side security features, programmatic server applications for interfacing with appropriate application programming interfaces (APIs) over network 150, or other types of applications. Other applications 144 may contain software programs, executable by a processor, including a graphical user interface (GUI), configured to provide an interface to a user.

Additionally, service provider server 140 includes database 146. As previously discussed, user 102 and/or other users may establish one or more user accounts with service provider server 140. User accounts in database 146 may include user information, such as name, address, birthdate, payment/funding information, additional user financial information, and/or other desired user data. The accounts may be linked to through their respective user and/or device identifier. Thus, when an identifier is transmitted to service provider server 140, e.g. from user device 110 or other device attached to a person/animal, a user account may be found. In other embodiments, user 102 may not have previously established a user account and may provide other information to service provider server 140, such as location information, connection notifications, etc., as previously discussed.

In various embodiments, service provider server 140 includes at least one network interface component 148 adapted to communicate user device 110 and/or home location beacon 130 over network 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

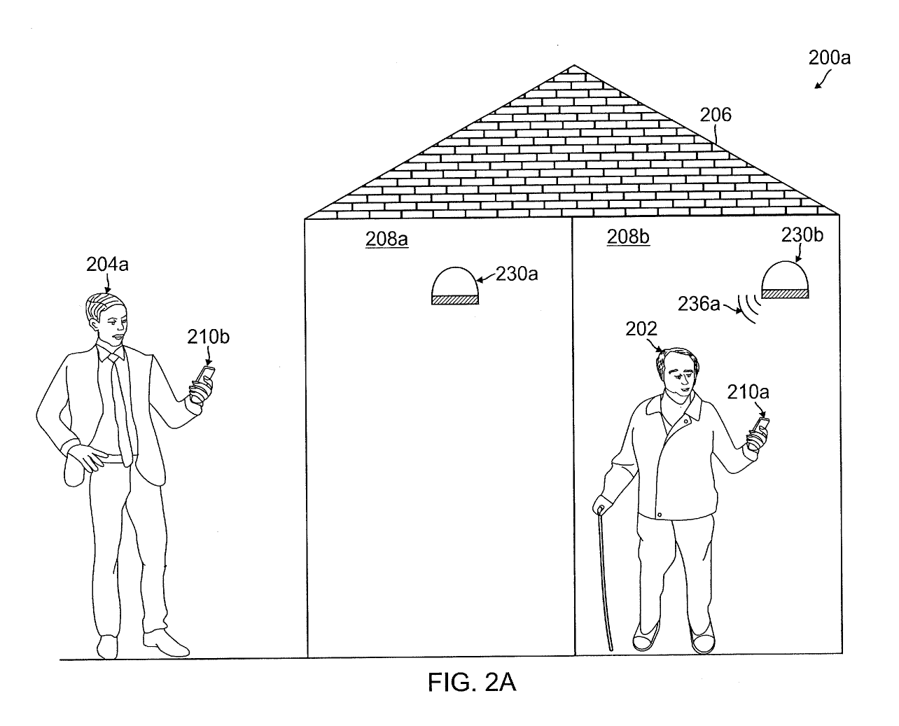

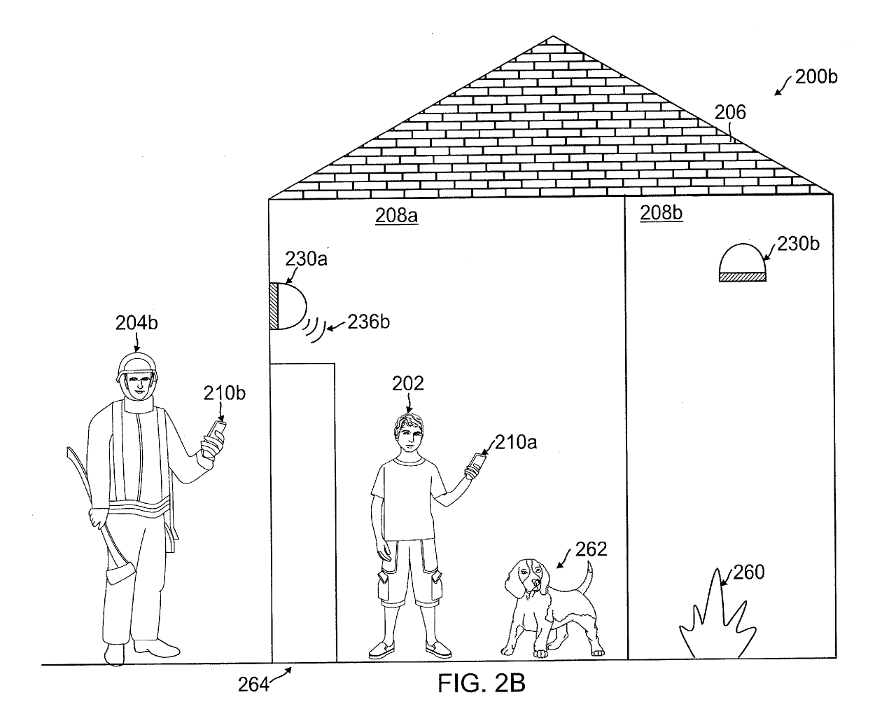

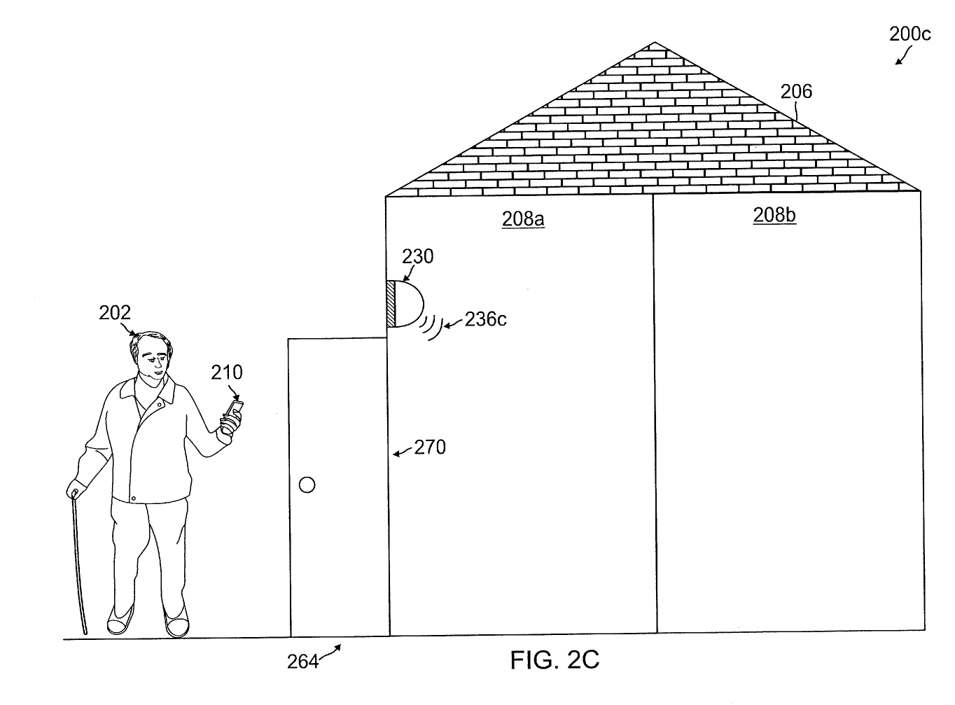

FIG. 2A is an exemplary environment displaying remote monitoring of a ward by their guardian, according to an embodiment. Environment 200a of FIG. 2A includes a user 202 corresponding generally to user 102 of FIG. 1. Moreover, environment 200a includes a user device 210a and a user device 210b corresponding generally to user device 110 of FIG. 1. Environment 200a also includes a home location beacon 230a and a home location beacon 230b corresponding generally to home location beacon 130 of FIG. 1.

As shown in environment 200a, an elderly user 202 may possess a user device 210a. User device 210a may be utilized to check-in or transmit identification information to a wireless beacon, thereby associating user 202 with the location in sufficient proximity to the wireless beacon to communicate with the wireless beacon using user device 210a. In environment 200a, a home 206 may have a plurality of rooms, such as a room 208a and a room 208b. Also shown in environment 200a are home location beacon 230a in room 208a and home location beacon 230b in room 208b. Home location beacon 230a may be set up so that an area of broadcast of a check-in request or distance that a user device can connect to home location beacon 230a is limited to room 208a. For example, an administrator (e.g., an owner, such as user 202) may limit the range of home location beacon 230a. The range may also be limited by the position of home location beacon 230a in room 208a or the properties of room 208a, such as walls and the layout/configuration of room 208a. In other embodiments, the range of home location beacon 208a may be even further limited within room 208a, such as a subset of room 208a. Thus, in such embodiments, room 208a may include a plurality of wireless beacons. Home location beacon 230b may similarly be limited to room 208b, so that a connection to home location beacon 230a associates user 202 with room 208a and a connection with home location beacon 230b associated user 202 with room 208b.

In environment 200a, user 202 has entered and is residing in room 208b. Thus, a connection 236a is established between user device 210a and home location beacon 230b. Connection 236a may also correspond to a plurality of connections established between user device 210a and home location beacon 230b. For example, the movement of user 202 may be tracked throughout home 206. Thus, connection 236a may correspond to all connections by user device 210a with home location beacon 230a and/or home location beacon 230b.

Based on connection 236a, user 204a may be updated on user device 210b with information for user 202. For example, user 204a may correspond to a guardian for user 202 (e.g., an adult child or caretaker of an elderly individual). Thus, user 204a may track if user 202 has moved to room 208b at an unexpected time, such as late at night, or duration. Additionally, user 204a may also monitor user 202's behavior over a period of time using user device 210b based on a plurality of connections in connection 236a.

FIG. 2B is an exemplary environment displaying remote monitoring of a user and pet at a home location during an emergency, according to an embodiment. Environment 200b of FIG. 2B includes a user 202 corresponding generally to user 102 of FIG. 1. Moreover, environment 200b includes a user device 210a and a user device 210b corresponding generally to user device 110 of FIG. 1. Environment 200b also includes a home location beacon 230a and a home location beacon 230b corresponding generally to home location beacon 130 of FIG. 1.

Environment 200b includes a home 206 with rooms 208a and 208b having home location beacon 230a and home location beacon 230b, respectively. Home 206 and home location beacons 230a/230b may be set up in a similar fashion to home 206 and home location beacons 230a/230b in environment 200a of FIG. 2A. Thus, home location beacon 230a may be limited to room 208a and home location beacon 230b may be limited to room 208b.

In environment 200b, an emergency 260 is occurring at home 206. Emergency 260 may require the assistance of a user 204b, corresponding to an emergency responder/personnel capable of assisting during emergency 260. In environment 200b, user device 210a is maintained/held by user 202. Thus, using home location beacon 230a, a connection 236b is established between home location beacon 230a and user device 210a. Due to connection 236b, it may be determined that user 202 is located in room 208a. User 204b may be updated of connection 236b, which may inform user 204b that user 202 is located in room 208a. User 204b may then provide assistance to user 202 knowing that user 202 is located in room 208a of home 206.

In various embodiments, a door 264 may include networked/smart locks. User 204b or another user may utilize user device 210b to activate or deactivate those locks in order to provide assistance to user 202 and/or enable user 202 to exit from emergency 260. In other embodiments, door 264 may correspond more generally to a garage door, a security gate, windows, or other entryway that may prevent user 202 from moving or impede user 204b in providing assistance to user 202. Moreover, user 204b may also use user device 210b to close or lock door 264 in order to prevent user 202 from re-entering home 206 during emergency 260.

In environment 200b, an animal 262 may also be located in home 206. Using home location beacon 230a/230b, the location of animal 262 may also be determined in home 206. For example, a small device may be embedded in a collar of animal 262 and be configured to establish connections with home location beacons 230a/230b. Once a connection is established between the device and one or more of home location beacons 230a/230b, the location of animal 262 in home 206 may be determined. Thus, user 204a may also provide assistance to animal 262. Moreover, in certain embodiments, door 264 may include an automatic opener for animal 262, such as “doggy doors” that enable dogs/cats to exit and enter a home. In such examples, home location beacon 230a may be connected to door 264 and enable animal 262 to activate the automatic door opener by approaching door 264. In the event of emergency 260, door 264 may be automatically opened or activated by user 204b to enable animal 262 to exit home 206 quickly. Door 264 may also be configured to prevent animal 262 from re-entry to home 206 after animal 262 has exited home 206.

FIG. 2C is an exemplary environment displaying remote monitoring of dangerous or risky situations while a user is away from home, according to an embodiment. Environment 200c of FIG. 2C includes a user 202 corresponding generally to user 102 of FIG. 1. Moreover, environment 200C includes a user device 210 corresponding generally to user device 110 of FIG. 1. Environment 200c also includes a home location beacon 230 corresponding generally to home location beacon 130 of FIG.

In environment 200c, user 202 has left home 206. Thus, user device 210 will have become disconnected from home location beacon. Therefore, when home location beacon 230 attempts to transmit and/or receive connection 236c, home location beacon 230 may not connect to user device 210. Using this information, it may be determined that user 202 is not at home 206 by a server. Thus, any dangerous and/or undesirable situations occurring at home 206 may be transmitted to user device 210 by the server for viewing by user 202.

For example, in environment 200c, door 264 may be left open/unlocked. Thus, situation 270 may correspond to an undesirable situation that may present risk to user 202. In other embodiments, situation 270 may correspond to other dangerous/undesirable situations, such as appliances in an “on” position, gas/water leaks, etc. Since situation 270 presents potential risk to user 202, user 202 may be updated of situation 270 on user device 210. User 202 may also utilize user device 210 to remedy the situation in various embodiments, such as by closing/locking a door, turning off an appliance, etc.

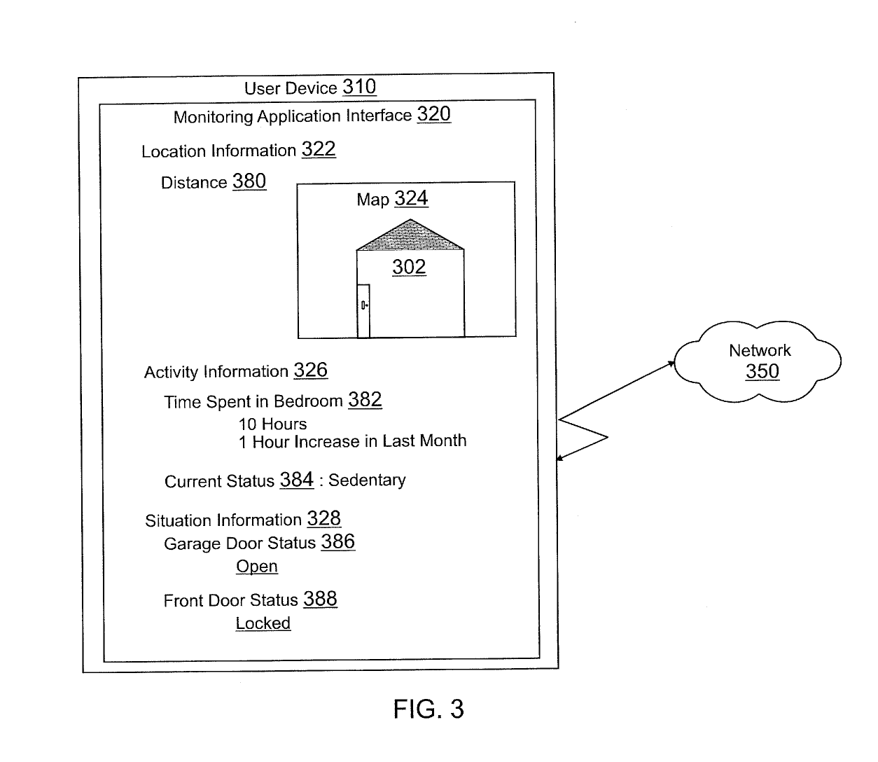

FIG. 3 is an exemplary display screen of a user device showing monitored information for a user at a home location, according to an embodiment. FIG. 3 includes a user device 310 and a network 250 corresponding generally to user device 110 and network 150, respectively, of FIG. 1.

User device 310 displays a monitoring application interface 320 having similar executed features and processes discussed in reference to monitoring application 112 of FIG. 1. User device 310 may receive information over network 350 that may be presented to a user (not shown) through monitoring application interface 320. Monitoring application interface 320 displays location information 322, a map 324, activity information 326, and situation information 328. Location information 322 includes a distance 380 next to map 324. Location information 322 may be utilized to determine a position/area of a person/animal having a device connected to a wireless beacon. Thus, distance 380 may show a distance from user device 310 to the position/area of the person/animal. User device 310 may include a mapping (e.g., GPS) application to assist in determining distance 380. Additionally, map 324 may display a map of the location where the person/animal is located in order to assist the user of user device 310 in locating the person/animal.

Activity information 326 may correspond to information determined based on connections between a device on a person/animal and wireless beacons distributed throughout a location. Thus, activity information 326 includes time spent in bedroom 382, which displays a daily amount of time spent in a bedroom by the person/animal, and an increase over a normal amount of time spent in a bedroom. As previously discussed, activity information 326 may be determined for a daily deviation from a normal amount, or may be analyzed over a longer period. Additionally, activity information 326 includes a current status 284 displaying a current activity of the person/animal. Current status 284 may be determined based on the movement of the person/animal throughout a location.

Situation information 328 may be displayed to the user in order to enable the user to determine if any potentially adverse situations arise at a location while the user is away from the location. Thus, situation information 328 includes a status 386 for a garage door, and a status 388 for a front door. As shown in FIG. 3, status 386 alerts the user of user device 310 that the garage door is open, while status 388 displays that the front door is locked. In certain embodiments, the user may utilize monitoring application interface 320 to close and/or lock the garage door under status 386.

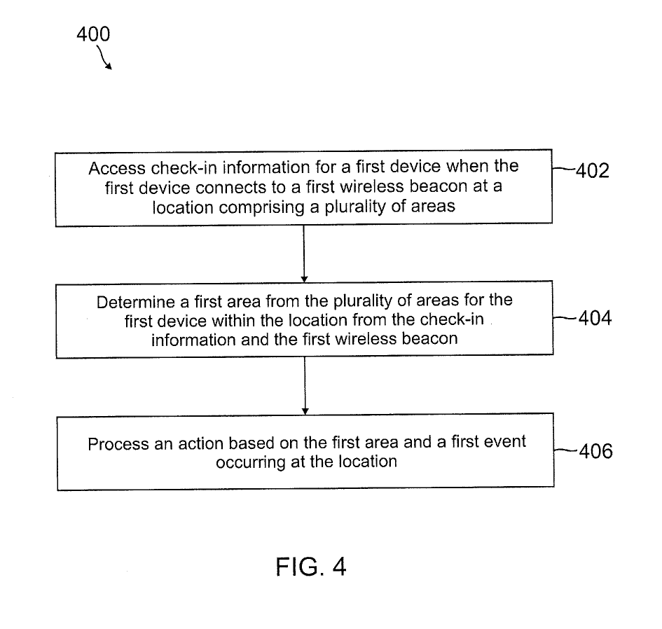

FIG. 4 is a flowchart of an exemplary process by a server for remote monitoring of users at a home location, according to an embodiment. Note that one or more steps, processes, and methods described herein may be omitted, performed in a different sequence, or combined as desired or appropriate.

At step 402, check-in information for a first device is accessed when the first device connects to a first wireless beacon at a location comprising a plurality of areas. The first device and the wireless beacon may connect using one of near field communication, radio communication, infrared communication, Bluetooth communication, and Bluetooth Low Energy (BLE) communication. Thus, the first device may comprise one of a BLE communication module, and LTE Direct communication module, and a radio-frequency identification (RFID) tag. The first wireless beacon may be range limited to a first area in the plurality of areas and the location may further comprise a plurality of wireless beacons each corresponding to one of the plurality of areas. For example, the location may correspond to a home having 3 rooms, where a wireless beacon is established in each room and provides communications with device in only that room. The first device may be attached to a person or an animal at that location, such as a mobile phone, a module attached to an article of clothing or jewelry, a wearable device, etc. In other embodiments, the check-in information may correspond to location information, such as just information of a connection between the first device and the first wireless beacon.

A first area from the plurality of areas is determined for the first device within the location from the check-in information and the first wireless beacon, at step 404. In other embodiments, a position for the first device within the location is determined from the location information. Also using the check-in information, it may be determined that the first user has left the location when the first device disconnects from the wireless beacon.

At step 406, an action is processed based on the first area and a first event occurring at the location. For example, prior to the action being processed, a movement of a first user between the plurality of areas may be monitored using the plurality of wireless beacons and the first device. Thus, the action may comprise an alert to a second user based on the movement. The movement may be monitored over a period of time to determine an activity level for the first user, where the action is further processed based on the activity level. In certain embodiments, the event may also comprise a lack of change of the movement by the first user. Thus, if the first user is exhibiting strange symptoms, or has not moved for a while, another user may be alerted to provide aid to the first user.

The position of the first device may be communicated to an entity based on an event occurring at the location. The event may comprise an emergency, such as a fire or an accident. Thus, the entity may correspond to an emergency responder, a guardian, a parent, and an owner. A second device may display the position of the first device within the location to enable the entity to provide assistance to a first user having the first device. Moreover, the wireless beacon may determine an area within the location where the event/emergency is occurring, and provide the second device with the area and the event. For example, the wireless beacon may be incorporated in a smoke detector and transmit an alert to an emergency responder when the smoke detector detects an emergency. The wireless beacon may also be attached to an automatic door opener for a door and open or close the door using the automatic door opener based on the emergency and the person or animal. The wireless beacon may also prevent re-entry to the location based on the emergency and using the automatic door opener.

A first user may be alerted of a situation at the location, in various embodiments. For example, the situation may comprise at least one of an open door or garage, an unlocked door, an appliance operating without user supervision, and a gas or water leak. Additionally, a geo-position of at least one other user in proximity to the location may be determined, and the at least one other user may be alerted of the situation based on the geo-position. Thus, a user closest to the location may thereby remedy the situation.

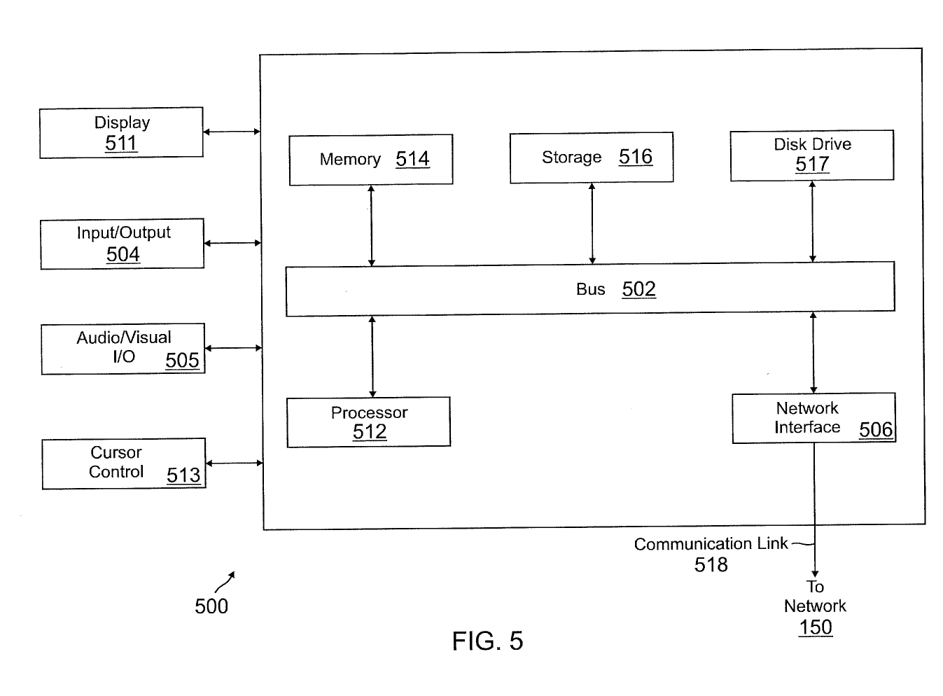

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing check-in information for a first device; and
one or more hardware processors in communication with the non-transitory memory and configured to:
access the check-in information for the first device when the first device connects to a first wireless beacon at a location comprising a plurality of areas;
determine a first area from the plurality of areas for the first device within the location from the check-in information and the first wireless beacon; and
process an action based on the first area and a first event occurring at the location.

2. The system of claim 1, wherein the first device and the wireless beacon connect using one of near field communication, radio communication, infrared communication, Bluetooth communication, and Bluetooth Low Energy (BLE) communication.

3. The system of claim 1, wherein the first device comprises one of a BLE communication module, and LTE Direct communication module, and a radio-frequency identification (RFID) tag.

4. The system of claim 1, wherein the first wireless beacon is range limited to the first area.

5. The system of claim 1, wherein the location further comprises a plurality of wireless beacons each corresponding to one of the plurality of areas.

6. The system of claim 5, wherein prior to the action being processed, the one or more hardware processors is further configured to:
monitor a movement of a first user between the plurality of areas using the plurality of wireless beacons and the first device,
wherein the action comprises an alert to a second user based on the movement.

7. The system of claim 6, wherein the movement is monitored over a period of time to determine an activity level for the first user, and wherein the action is further processed based on the activity level.

8. The system of claim 6, wherein the event comprises a lack of change of the movement by the first user.

9. A method comprising:
receive location information for a first device when the first device connects to a wireless beacon at a location;
determine a position for the first device within the location from the location information; and
communicate the position to an entity based on an event occurring at the location.

10. The method of claim 9, wherein the event comprises an emergency occurring at the location.

11. The method of claim 10, wherein the first device is attached to a person or an animal.

12. The method of claim 11, wherein the entity comprises one of an emergency responder, a guardian, a parent, and an owner.

13. The method of claim 12, wherein a second device displays the position of the first device within the location to the entity.

14. The method of claim 13, wherein the wireless beacon determines an area within the location where the event is occurring, and wherein the second device further displays the area and the event.

15. The method of claim 11, wherein the wireless beacon is attached to an automatic door opener for a door, and wherein the wireless beacon opens or closes the door using the automatic door opener based on the emergency and the person or animal.

16. The method of claim 15, wherein the wireless beacon prevents re-entry to the location based on the emergency using the automatic door opener.

17. The method of claim 11, wherein the wireless beacon is incorporated in a smoke detector, and wherein the wireless beacon transmits an alert to an emergency responder when the smoke detector detects an emergency.

18. A non-transitory computer-readable medium comprising instructions which, in response to execution by a computer system, cause the computer system to perform a method comprising:
access check-in information for a first user when a first device connects to a wireless beacon at a location;
determine that the first user has left the location when the first device disconnects from the first wireless beacon; and
alert the first user of a situation at the location.

19. The non-transitory computer-readable medium of claim 18, wherein the method further comprises:
determining a geo-position of at least one other user in proximity to the location; and
alert the at least one other user of the situation based on the geo-position.

20. The non-transitory computer-readable medium of claim 16, wherein the situation comprises at least one of an open door or garage, an unlocked door, an appliance operating without user supervision, and a gas or water leak.
